(19) United States
(12) Patent Application Publication
(10) Pub. No.: US 2011/0179194 A1
(43) Pub. Date: Jul. 21, 2011

(54) METHODS FOR HANDLING REMOVAL OF MEDIA STORAGE DEVICES

(75) Inventors: Dallas B. De Atley, San Francisco, CA (US); John A. Wright, San Francisco, CA (US); Baskaran Subramaniam, San Jose, CA (US)

(73) Assignee: APPLE INC., Cupertino, CA (US)

(21) Appl. No.: 12/688,728

(22) Filed: Jan. 15, 2010

(51) Int. Cl. G06F 13/12; G06F 3/00; G06F 12/00

(52) U.S. Cl. 710/13; 711/115; 710/15; 711/E12.001

(57) ABSTRACT

In response to an insertion of a removable storage device into a data processing system, the removable storage device is automatically mounted by an operating system (OS) in a file system of the data processing system. A daemon is configured to determine a type of media content stored in the removable storage device and to identify a program that is associated with the type of the media content of the removable storage device. The identified program is automatically launched for accessing the media content of the removable storage device. In response to a termination of the program, the removable storage device is automatically unmounted from the file system of the data processing system without user intervention.

### FIELD OF THE INVENTION

Embodiments of the invention relate generally to the field of removable storage devices; and more particularly, to handling removal of media storage devices.

### BACKGROUND

The use of removable storage devices that can be dynamically attached and removed from a data processing system has been growing rapidly. The universal serial bus (USB) standard for example has enabled numerous storage devices to be dynamically connected and removed from a data processing system even during the operation of the a data processing system. Among these removable storage devices are mass storage devices such as flash drives, and multimedia players. These devices can be attached to a data processing system and then later be removed.

Typically, a removable storage device has to be mounted as a storage disk under a file system of a data processing system. When a user physically removes the removable storage device from the data processing system without unmounting the device, a warning message is displayed indicating that such a removal may not be a safe removal. However, under certain circumstances, a user may have finished accessing the removable storage device and he/she may expect such a removal is a safe removal. As a result, such a warning message sometimes tends to be annoying.

### SUMMARY OF THE DESCRIPTION

According to some embodiments, a daemon or a monitoring unit is utilized, as a part of an operating system (OS) of a data processing system, to monitor certain programs or applications, such as, for example, media applications (e.g., photo applications), for accessing content (e.g., media content such as photo images, audio, and/or video files) stored in a removable storage device (e.g., flash memory device). When a program accessing the removable storage device has been terminated, the daemon may automatically unmount the removable storage device or cause the removable storage device to be unmounted from a file system of the data processing system. That is, the removable storage device is automatically unmounted when the removable storage device still remains inserted in the system and/or without knowledge of a user. The removable storage device may be unmounted when there is no other program currently accessing the removable storage device. As a result, subsequently when the removable storage device is physically removed from the data processing system, since the removable storage device has been unmounted, no warning message is displayed.

According to another embodiment, when a removable storage device is inserted into a port or interface (e.g., universal serial bus or USB, secured digital or SD, etc.), the removable storage device is automatically mounted by an operating system of the data processing system. In addition, the daemon may access the removable storage device to determine a type of content (e.g., image, audio, video files or any other content such as eBook content) stored in the removable storage device. Based on the type of the content, a program (e.g., media application such as a media player or eBook application) is identified and automatically launched, for example, without user intervention. In a particular embodiment, the determination of the type of content may be performed based on whether the removable storage device contains a particular directory or folder, file extension, or metadata. For example, a removable storage device may be a memory card (e.g., an SD card) used within a digital media capturing device such as a digital camera. Typically, when a digital media capturing device captures and stores digital media content in a removable storage device, a file system of the digital media capturing device may create a specific or predetermined folder under which the digital media content is stored. In the example of a digital camera, a digital camera images (DCIM) folder will be created by the file system of the digital camera. Thus, by detecting such a directory or folder, the type of the digital media content stored in the removable storage device can be determined. According to a further embodiment, once the type of the content has been determined, at least some of the content may be automatically imported into the data processing system.

Other features of the present invention will be apparent from the accompanying drawings and from the detailed description which follows.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating an example of a data processing system according to one embodiment.

FIG. 2 is a flow diagram illustrating a method for handling an insertion of a removable storage device according to one embodiment of the invention.

FIG. 3 is a flow diagram illustrating a method for handling a removal of a removable storage device according to one embodiment of the invention.

FIG. 4 is a block diagram of a data processing system, which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

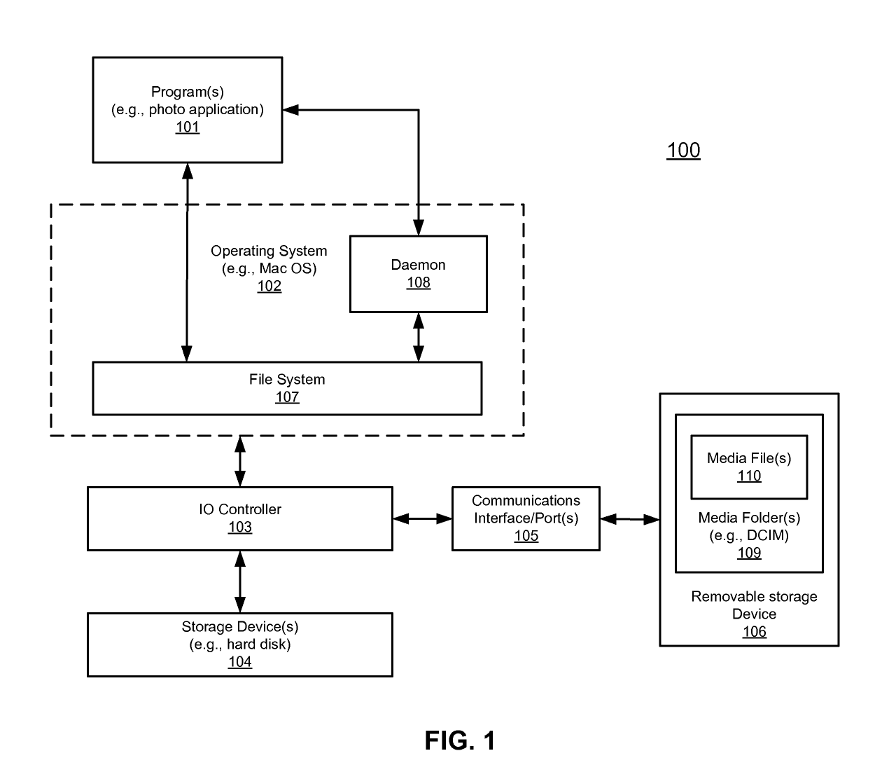

FIG. 1 is a block diagram illustrating an example of a data processing system according to one embodiment. Referring to FIG. 1, system 100 includes, but not limited to, one or more applications or programs 101 communicatively coupled to an operating system 102 in order to access data stored in a storage device 104 and to access data stored in a removable storage device 106 via an input/output (IO) controller 103 and/or IO port 105. OS 102 may be any kind of operating systems, such as, for example, Mac OS™ from Apple Inc. of Cupertino, Calif., Windows™ operating system from Microsoft Corporation of Redmond, Wash., or LINUX operating system. IO controller 103 (also referred to as a part of a south bridge) can be a part of any kind of chipsets. IO interface port 105 may be any kind of communications interface such as a USB port, Firewire port, or any kind of memory card interfaces. Removable storage device 106 may be any kind of removable storage devices (e.g., flash memory devices). For example, removable storage device 106 may be any one of CompactFlash, Smart Media, Memory Stick, MultimediaCard, xD-Picture Card, SD card, SDHC card, miniSD card, and/or a USB Flash memory card, etc.

In one embodiment, system 100 further includes a daemon or monitoring module 108, which may be implemented as a part of OS 102, communicatively coupled to file system 107. Daemon 108 is also coupled to a system monitor or device manager (not shown) to monitor insertion and/or removal of removable storage device 106 into/from removable device interface port 105. Daemon 108 may be a process executed at a user space or a kernel space of the OS 102. When removable storage device 106 is inserted into interface port 105, the removable storage device 106 is mounted by OS 102 and/or file system 107 and presented as a separate mass storage device by the file system 107.

According to one embodiment, when removable storage device 106 is inserted and mounted, daemon 108 is configured to access the removable storage device 106 to determine a type of content (e.g., image, audio, video files, or any other content) stored in the removable storage device 106. The type of the content can be determined based on a variety of information stored within the removable storage device. For example, the type of a file can be determined based on its filename extension and/or its file metadata. For example, an eBook file can be determined based on its filename extension, such as, for example, “*.azw” for Amazon's Kindle™, “*.lit” for Microsoft Reader™, and *.pdb” for Palm eReader™, etc. In this example, system 100 may be utilized as a part of an eBook reader device. Based on the type of the content, a program (e.g., media application such as a media player or the associated eBook program), in this example, program 101, is identified and launched. Program 101 may be launched automatically without user intervention. Program 101 may be previously installed or stored within storage device 104. Alternatively, program 101 may be stored within removable storage device 106.

In a particular embodiment, the determination of the media type may be performed based on whether the removable storage device 106 contains a particular directory or folder, or any other data stored within removable storage device 106. For example, a removable storage device may be a memory card (e.g., an SD card) used within a digital media capturing device such as a digital camera. Typically, when a digital media capturing device captures and stores digital media content (e.g., digital images) in a removable storage device, a file system of the digital media capturing device may create a specific or predetermined folder or directory under which the digital media content is stored. In the example of a digital camera, a digital camera images (DCIM) folder will be created, for example, as a root directory, by the file system of the digital camera. Thus, by detecting such a directory or folder, the type of the digital media content stored in the removable storage device can be determined. Note that other mechanisms may also be utilized in detecting the type of the content, such as, for example, by examining formats of the files (e.g., metadata) of the removable storage device, using filename extensions, or metadata of the files as is known.

In this example, daemon 108, which may be a kernel process or user space process, accesses removable storage device 106 to determine whether removable storage device 106 contains a particular folder or directory 109. Based on the detection of directory or folder 109, daemon 108 identifies program 101 that is associated with media content 110 stored in removable storage device 106, and daemon 108 is configured to automatically launch program 101. According to a further embodiment, once the type of the media content has been determined, at least some media content may be automatically imported into and/or stored in storage device 104 of system 100. Again, program 101 may be previously installed or stored within storage device 104. Alternatively, program 101 may be at least in part provided within removable storage device 106, such as, for example, a codec, decryption code, or other program code that may be provided with the content as a plug-in.

According to one embodiment, daemon 108 is also configured to monitor activities of program 101. When program 101 is terminated, for example, by a user or a process manager (not shown) of operating system 102, daemon 108 may unmount or cause removable storage device 106 to be unmounted from file system 107. Removable storage device 106 may be automatically unmounted without user intervention and/or knowledge. Removable storage device 106 may be unmounted even if it is still inserted into communications interface or port 105. For example, when removable storage device 106 is inserted into port 105, an associated program (e.g., program 101) is automatically launched and certain content stored in removable storage device 106 may be automatically imported into system 100. Thereafter, the program is automatically terminated. In response to termination of the program, daemon 108 may cause removable storage device 106 to be automatically unmounted from file system 107. In this example, the intention of the user is to import the content from removable storage device 106 and thereafter, the user may expect that removable storage device 106 is safely removable and would not expect to see a message displayed concerning the safe removal of removable storage device.

In addition, prior to unmounting removable storage device 106, daemon 108 may also check whether there is another program or process accessing removable storage device. Removable storage device 106 may only be unmounted when there is no program or process currently accessing removable storage device 106. Furthermore, daemon 108 may communicate with file system 107 to determine whether removable storage device 106 is safely removable and if so, daemon 108 may prevent a message from being displayed concerning the safe removal of removable storage device. Note that some or all of the components as shown in FIG. 1 may be implemented in software, firmware, hardware, or a combination thereof.

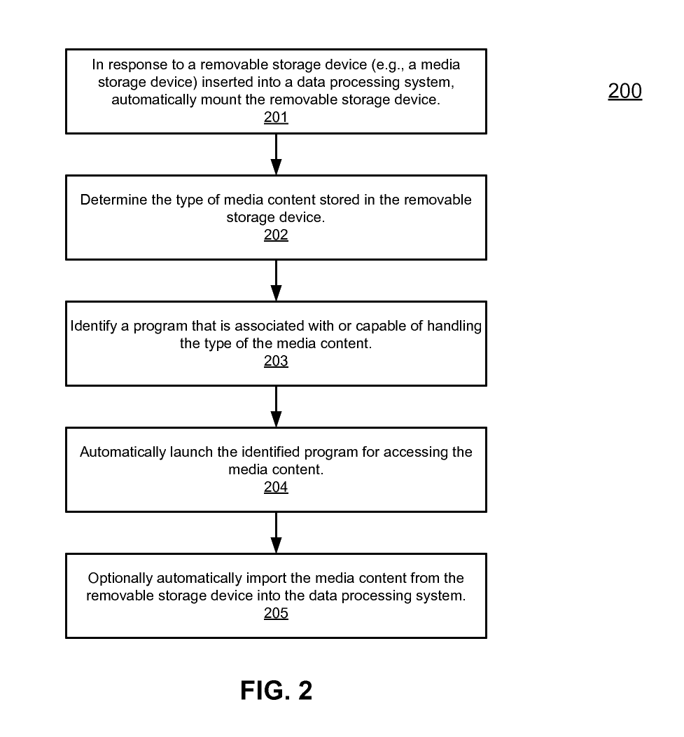

FIG. 2 is a flow diagram illustrating a method for handling an insertion of a removable storage device according to one embodiment of the invention. Note that method 200 may be performed by processing logic which may include software, firmware, hardware, or a combination thereof. For example, method 200 may be performed by daemon 108 of FIG. 1, which may be a kernel process or a user space process of OS 102. Referring to FIG. 2, in response to a signal indicating that a removable storage device is inserted into a communications interface or port of a data processing system, at block 201, processing logic automatically mount the removable storage device in a file system of the data processing system. The signal indicating an insertion of the removable storage device may be received from a system monitoring logic, such as a device manager or a plug-and-play manager. At block 202, processing logic determines the type of content stored in the removable storage device using some techniques described above. In one embodiment, processing logic may access the removable storage device to determine whether the removable storage device contains a specific directory or folder, such as a DCIM folder, in order to determine the type of the content.

Based on the type of the content, at block 203, processing logic identifies a program that is associated with or capable of handling the type of content. For example, if there is a DCIM directory in the removable storage device, most likely the media content is related to digital camera images. As a result, an image editing program may be identified. At block 204, the identified program is automatically launched for accessing the content stored in the removable storage device. Optionally, at block 205, the content of the removable storage device may be automatically imported into the data processing system.

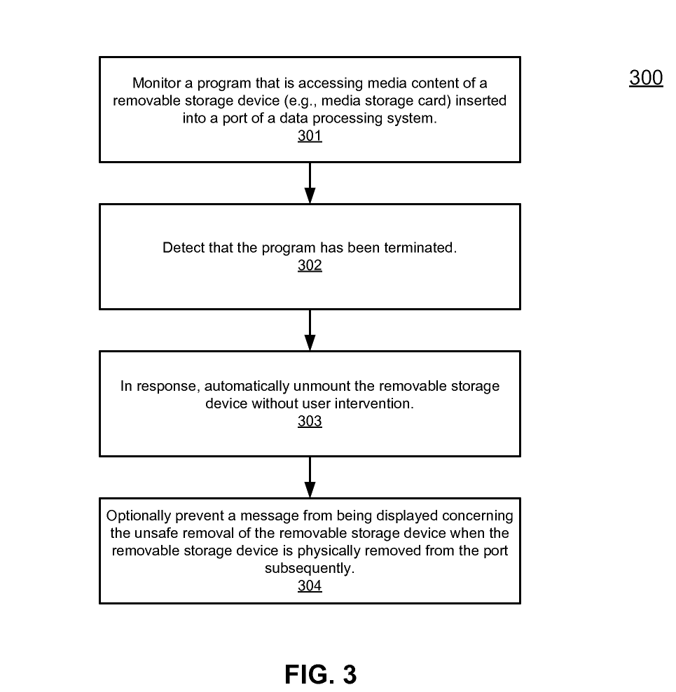

FIG. 3 is a flow diagram illustrating a method for handling a removal of a removable storage device according to one embodiment of the invention. Note that method 300 may be performed by processing logic which may include software, firmware, hardware, or a combination thereof. For example, method 300 may be performed by daemon 108 of FIG. 1. Referring to FIG. 3, at block 301, processing logic monitors a program that is currently accessing content of a removable storage device inserted into a communications interface or port (e.g., USB port or Firewire port) of a data processing system. At block 302, it is detected that the program has been terminated. In response, at block 303, the removable storage device is automatically unmounted without user intervention from a file system of the data processing system. That is, the removable storage device is unmounted once the program has exited from accessing media content of the removable storage device, while the removable storage device is still inserted. The removable storage device may be unmounted without the knowledge of a user. In one embodiment, the removable storage device may be unmounted only when no program is currently accessing the removable storage device. Optionally when the removable storage device is physically removed from the port subsequently, at block 204, processing logic prevents a message from being displayed concerning an unsafe removal of the removable storage device.

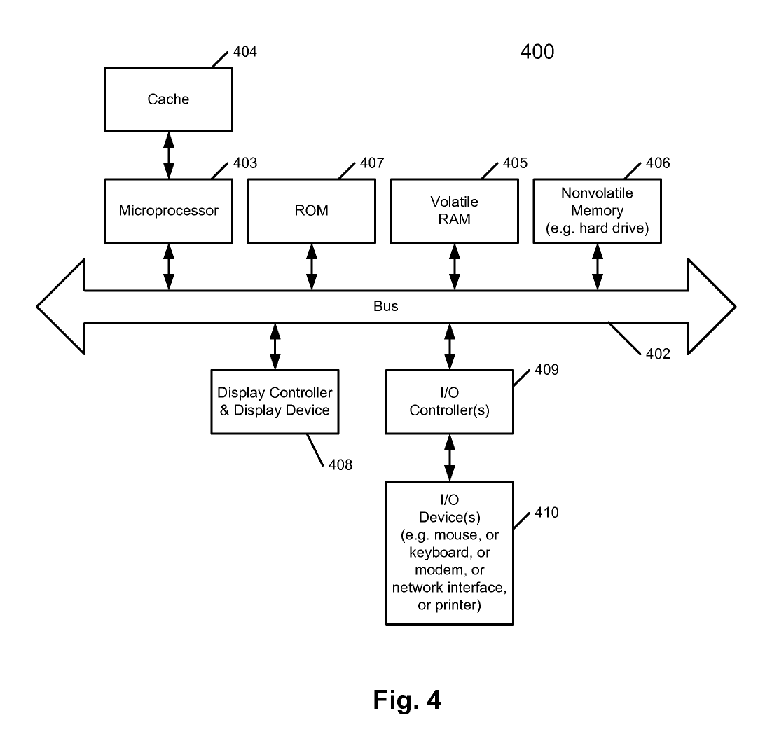

FIG. 4 is a block diagram of a data processing system, which may be used with one embodiment of the invention. For example, the system 400 may be implemented as system 100 of FIG. 1. Note that while FIG. 4 illustrates various components of a computer system, it is not intended to represent any particular architecture or manner of interconnecting the components; as such details are not germane to the present invention. It will also be appreciated that network computers, handheld computers, cell phones and other data processing systems which have fewer components or perhaps more components may also be used with the present invention. The computer system of FIG. 4 may, for example, be an Apple Macintosh computer or MacBook, or an IBM compatible PC.

As shown in FIG. 4, the computer system 400, which is a form of a data processing system, includes a bus or interconnect 402 which is coupled to one or more microprocessors 403 and a ROM 407, a volatile RAM 405, and a non-volatile memory 406. The microprocessor 403 is coupled to cache memory 404. The bus 402 interconnects these various components together and also interconnects these components 403, 407, 405, and 406 to a display controller and display device 408, as well as to input/output (I/O) devices 410, which may be mice, keyboards, modems, network interfaces, printers, and other devices which are well-known in the art.

Typically, the input/output devices 410 are coupled to the system through input/output controllers 409. The volatile RAM 405 is typically implemented as dynamic RAM (DRAM) which requires power continuously in order to refresh or maintain the data in the memory. The non-volatile memory 406 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 4 shows that the non-volatile memory is a local device coupled directly to the rest of the components in the data processing system, the present invention may utilize a non-volatile memory which is remote from the system; such as, a network storage device which is coupled to the data processing system through a network interface such as a modem or Ethernet interface. The bus 402 may include one or more buses connected to each other through various bridges, controllers, and/or adapters, as is well-known in the art. In one embodiment, the I/O controller 409 includes a USB (Universal Serial Bus) adapter for controlling USB peripherals. Alternatively, I/O controller 409 may include an IEEE-1394 adapter, also known as FireWire adapter, for controlling FireWire devices.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine-implemented method, comprising:
in response to an insertion of a removable storage device into a data processing system, automatically mounting, by an operating system (OS), the removable storage device in a file system of the data processing system;
determining, by a daemon, a type of media content stored in the removable storage device;
identifying, by the daemon, a program that is associated with the type of the media content of the removable storage device;
automatically launching, by the daemon, the identified program for accessing the media content of the removable storage device; and
in response to a termination of the program, automatically unmounting, by the OS, the removable storage device from the file system of the data processing system without user intervention.

2. The method of claim 1, wherein determining a type of the media content comprises accessing the removable storage device to determine whether the removable storage device contains a predetermined item.

3. The method of claim 2, further comprising determining whether removable storage device contains a digital camera images (DCIM) directory to determine that the media content of the removable storage device includes digital camera images.

4. The method of claim 1, wherein the removable storage device is automatically unmounted from the file system while the removable storage device is still inserted in the data processing system.

5. The method of claim 4, wherein the removable storage device is automatically unmounted without knowledge of a user associated with the data processing system.

6. The method of claim 1, further comprising tracking in the file system whether the removable storage device is safely removable.

7. The method of claim 6, further comprising preventing a message from being displayed concerning an unsafe removal of the removable storage device, when the user subsequently removes the removable storage device from the data processing system if it is determined that the removable storage device is safely removable.

8. The method of claim 1, further comprising automatically importing, via the program, the media content of the removable storage device into a storage device of the data processing system.

9. The method of claim 1, wherein the removable storage device is one of a CompactFlash card, Smart Media card, Memory Stick, MultimediaCard, xD-Picture Card, SD card, SDHC card, and miniSD card.

10. A machine-readable storage medium having instructions stored therein, which when executed by a machine, cause the machine to perform a method, the method comprising:
in response to an insertion of a removable storage device into a data processing system, automatically mounting, by an operating system (OS), the removable storage device in a file system of the data processing system;
determining, by a daemon, a type of media content stored in the removable storage device;
identifying, by the daemon, a program that is associated with the type of the media content of the removable storage device;
automatically launching, by the daemon, the identified program for accessing the media content of the removable storage device; and
in response to a termination of the program, automatically unmounting, by the OS, the removable storage device from the file system of the data processing system without user intervention.

11. The machine-readable storage medium of claim 10, wherein determining a type of the media content comprises accessing the removable storage device to determine whether the removable storage device contains a predetermined item.

12. The machine-readable storage medium of claim 11, wherein the method further comprises determining whether removable storage device contains a digital camera images (DCIM) directory to determine that the media content of the removable storage device includes digital camera images.

13. The machine-readable storage medium of claim 10, wherein the removable storage device is automatically unmounted from the file system while the removable storage device is still inserted in the data processing system.

14. The machine-readable storage medium of claim 13, wherein the removable storage device is automatically unmounted without knowledge of a user associated with the data processing system.

15. The machine-readable storage medium of claim 10, further comprising tracking in the file system whether the removable storage device is safely removable.

16. The machine-readable storage medium of claim 10, wherein the method further comprises preventing a message from being displayed concerning an unsafe removal of the removable storage device, when the user subsequently removes the removable storage device from the data processing system if it is determined that the removable storage device is safely removable.

17. The machine-readable storage medium of claim 10, wherein the method further comprises automatically importing, via the program, the media content of the removable storage device into a storage device of the data processing system.

18. The machine-readable storage medium of claim 10, wherein the removable storage device is one of a CompactFlash card, Smart Media card, Memory Stick, MultimediaCard, xD-Picture Card, SD card, SDHC card, and miniSD card.

19. A data processing system, comprising:
a communications port;
a device manager to detect an insertion of a removable storage device into the communications port;
a operating system (OS) coupled to the device manager to automatically mount the removable storage device in a file system; and
a monitoring unit to determine a type of media content stored in the removable storage device, to identify a program that is associated with the type of the media content of the removable storage device, and to automatically launch the identified program for accessing the media content of the removable storage device, wherein in response to a termination of the program, the OS automatically unmounts the removable storage device from the file system of the data processing system without user intervention.

20. The system of claim 19, wherein the monitoring unit accesses the removable storage device to determine whether the removable storage device contains a predetermined folder, to determine the type of the media content.

21. The system of claim 20, wherein the monitoring unit further determines whether removable storage device contains a digital camera images (DCIM) directory to determine that the media content of the removable storage device includes digital camera images.

22. The system of claim 19, wherein the removable storage device is automatically unmounted from the file system while the removable storage device is still inserted in the communications port.

23. The system of claim 22, wherein the removable storage device is automatically unmounted without knowledge of a user.

24. The system of claim 19, wherein the file system is monitored whether the removable storage device is safely removable.

25. The system of claim 24, wherein a message is prevented from being displayed concerning an unsafe removal of the removable storage device, when the user subsequently removes the removable storage device from the communications port if it is determined that the removable storage device is safely removable.

26. The system of claim 19, wherein the media content is automatically imported, via the program, from the removable storage device into a storage device of the data processing system.

27. The system of claim 19, wherein the removable storage device is one of a CompactFlash card, Smart Media card, Memory Stick, MultimediaCard, xD-Picture Card, SD card, SDHC card, and miniSD card.
